(19) United States
(12) Patent Application Publication
(10) Pub. No.: US 2026/0312921 A1
(43) Pub. Date: Oct. 8, 2026

(54) HIERARCHICAL NETWORK DESIGN FOR DYNAMIC DATAFLOW ARCHITECTURES

(71) Applicant: NATIONAL UNIVERSITY OF SINGAPORE, Singapore (SG)

(72) Inventors: Jinho LEE, Singapore (SG); Burin AMORNPAISANNON, Singapore (SG); Trevor Erik CARLSON, Singapore (SG)

(73) Assignee: NATIONAL UNIVERSITY OF SINGAPORE, Singapore (SG)

(21) Appl. No.: 19/481,989

(22) PCT Filed: May 8, 2024
(86) PCT No.: PCT/SG2024/050297

§ 371 Date: Nov. 6, 2025

(30) Foreign Application Priority Data
May 19, 2023 (SG) 10202301419V

(51) Int. Cl. H04L 49/112; H04L 49/90

(52) U.S. Cl. CPC H04L 49/112; H04L 49/9026

(57) ABSTRACT

A processing device for dynamic dataflow architectures comprises a plurality of processing entities clusters (PCs) each having a plurality of processing entities Each of the PCs associated with switches that receive packets from the other PCs and store the received packets in FIFO buffers associated with the PCs. Each of the switches includes an arbiter for selecting a packet from one of the FIFO buffers for providing as input to the PC associated with the switch.

### TECHNICAL FIELD

The current disclosure relates to computer architectures and in particular to computers using dynamic dataflow architectures.

### BACKGROUND

In dataflow architectures the execution of instructions determined based on the availability of the inputs for the instructions. Dataflow architectures may be based on a plurality of processing entities that can be interconnected with each other in order to communicate data between the processing entities.

Due to the spatial nature of dataflow architectures, scaling up the design to support more complex workloads while maintaining high throughput has become challenging. High interconnect complexity can lead to higher power consumption, performance and chip area overheads. An alternative way is to use a more aggressive network in a cluster of processing elements (PEs) to increase performance and use a more flexible interconnect to connect multiple clusters together. For example, processing clusters of individual processing entities may be connected together in a mesh-network on chip architecture.

An additional, alternative and/or improved dataflow architecture is desirable.

### SUMMARY

In accordance with the present disclosure, there is provided a processing device comprising: a plurality of processing entity clusters (PCs); and a plurality of switches, each of the switches associated with a respective PC and comprising: a plurality of FIFO (First

Input First Output) packet buffers each associated with a respective PC of the plurality of PCs; and an arbiter to select a packet from the plurality of FIFO packet buffers and provide it as input to the PC associated with the respective switch.

In a further embodiment of the processing device, the PCs each comprise: a plurality of processing entities; and an external processing entity for controlling inbound and outbound packets to and from the PC.

In a further embodiment of the processing device, the external processing entity comprises an arbiter that selects packets received from the plurality of processing entities to provide as output from the PC, the selection based on ready signals from other PCs.

In a further embodiment of the processing device, the external processing entity comprises a plurality of FIFO buffers each associated with respective processing entities of the PC, the received packets stored in the FIFO buffers and retrieved by the arbiter.

In a further embodiment of the processing device, the arbiter of the external processing entity outputs an identifier of the PC with the output from the PC.

In accordance with the present disclosure, there is further provided a method of providing an interconnection between a plurality of processing clusters comprising: receiving packets from the plurality of processing clusters at a plurality of switches, each of the switches associated with a respective processing cluster; at each of the plurality of switches, storing the received packets in a first-in-first-out buffer of a plurality of FIFO buffers associated with the processing cluster the packets were received from; and at each of the switches, selecting a packet from one of the FIFO buffers of the respective switch and providing as input the packet to the processing cluster associated with the respective switch.

In a further embodiment of the method, the method further comprises: receiving the input packet at a respective processing cluster and storing in an input FIFO buffer and broadcasting a packet output from the FIFO buffer to all processing entities of the processing cluster.

In a further embodiment of the method, the method further comprises: receiving at an arbiter of a respective processing cluster ready signals from a plurality of processing clusters and selecting a packet from plurality of FIFO output buffers, each associated with a respective processing entity of the processing cluster; selecting one of the plurality of FIFO output buffers; and outputting the packet from the selected FIFO output buffer to the plurality of FIFO buffers of the switches.

This summary does not necessarily describe the entire scope of all aspects of the systems and methods for time-series forecasting. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a hierarchical dynamic dataflow architecture;

FIG. 2 depicts details of a processing cluster;

FIG. 3 depicts details of an external processing entity;

FIG. 4 depicts a method of communicating between processing clusters;

FIG. 5 depicts a method of providing external inputs to a processing cluster; and

FIG. 6 depicts a method of providing output from a processing cluster to other processing clusters.

### DETAILED DESCRIPTION

The current disclosure describes a hierarchical network design of processing entities that is suitable for dynamic dataflow architectures. The network of processing entities is built to guarantee packet order, allows clusters of processing elements connected using a more aggressive interconnect to connect to each other, and allows for high throughput.

The network design of processing entities described above provides higher performance than traditional mesh Network-on-Chip. However, the design may not be as scalable to large numbers of processing clusters as mesh Network-on-Chip designs. Using the network design of the processing entities as described herein, the number of processing clusters that can be deployed in a chip may be limited by the target achievable frequency. However, although the current design may not achieve the level of scalability that the traditional mesh Network-on-Chip can achieve, numerous applications do not require the high level of scalability, and the current network design can provide higher performance.

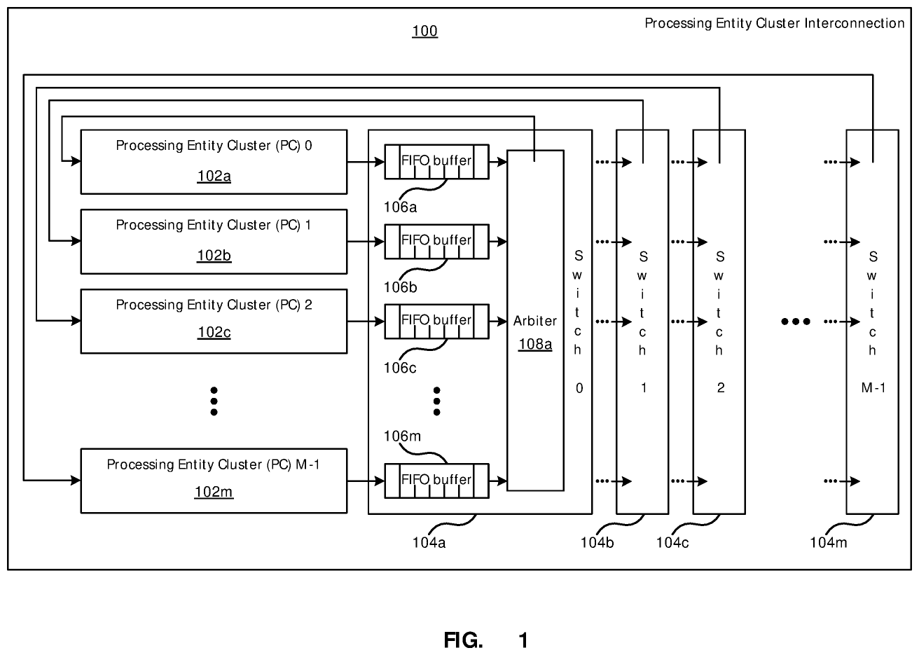

FIG. 1 depicts a hierarchical dynamic dataflow architecture. The processing entity cluster (PC) interconnect, or network design, 100 may be implemented in a chip or chips, including for example a field-programmable gate array (FPGA), application specific integrated circuits, or general dynamic dataflow processors. The PC interconnect 100 comprises a plurality of PCs 102a . . . 102m (referred to collectively as PCs 102). Each of the PCs 102 group together a plurality of individual processing entities capable of processing data. The hierarchical grouping of processing entities into the plurality of clusters may require some form of interconnection between the PCs in order to provide data from one PC to another.

In the architecture, the connection between PCs comprises a plurality of switches 104a . . . 104m (referred to collectively as switches 104). Each of the switches 104 is associated with one of the PCs 102. The switches 104 receive packets from all of the PCs 102 and provide input to the PC the switch is associated with. For example, switch 104a is depicted as being associated with the PC 104a and provides input to the PC 104a. Similarly, switch 104b is depicted as being associated with PC 102b, switch 104c is associated with PC 102c and switch 104m is associated with PC 104m.

Each of the switches 104 comprises a similar architecture as the depicted for switch 104a. As depicted, switch 104a comprises a plurality of FIFO (first-input-first-output) input buffers 106a . . . 106m (referred to collectively as input buffers 106). Each of the input buffers is associated with a respective one of the PCs 102. As depicted, input buffer 106a is associated with PC 102a, input buffer 106b is associated with PC 102b, etc. Each of the input buffers 106 receives data packets output from the PC the buffer is associated with. An arbiter 108a of the switch 104a selects a packet from one of the input buffers 106 and provides it to the PC the switch is associated with. Each switch has a plurality of input buffers each associated with a respective PC. A PC may broadcast a packet to the associated buffers in each switch. That is, PC 102a may output a packet to the input buffer 106a of switch 104a, as well as the input buffer of the other switches 102b . . . 102m.

The processing entity network depicted in FIG. 1 handles data transfer between PCs (inter-PC data transfer) and comprises multiple switches. A packet from each PC is multicast to all the switches at the same time to reduce latency. The switch comprises multiple FIFO buffers and an arbiter. The FIFOs are used to buffer packets from each PC, and the arbiter is used to pick one of the packets from the FIFOs to transfer data to the target PC the switch is associated with.

The use of FIFO buffers in the interconnect ensures that packet delivery order of each source-destination pair of PCs is maintained during the inter-PC data transfer. Although described as inter-PC transfer, the data transfer may be between processing entities in different PCs. Traditional mesh Network-on-Chips have used routing algorithms for the inter-PC data transfer that do not preserve packet order. Maintaining the packet delivery order can significantly simplify the program compilation phases as the compiler is not required to consider timing information to get an optimal solution and to ensure the correctness of the communication.

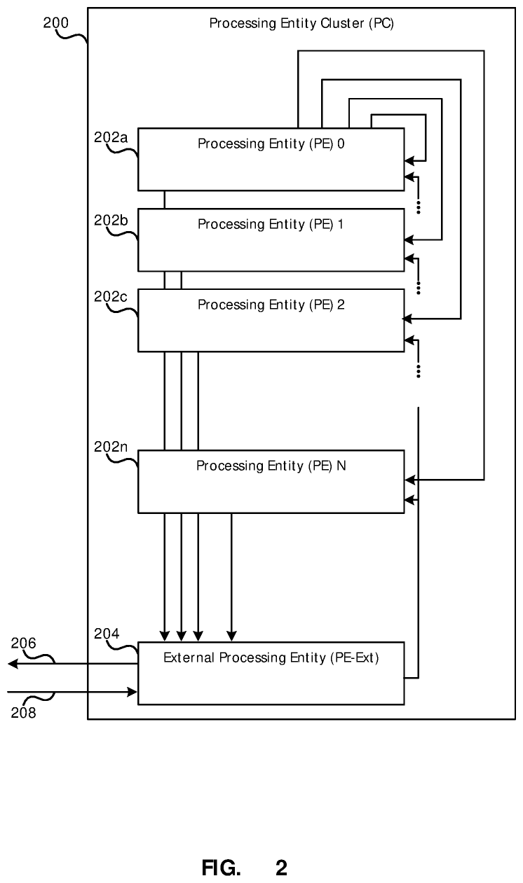

FIG. 2 depicts details of a processing cluster. The processing cluster architecture depicted in FIG. 2 may be used as any of the PCs 102 depicted in FIG. 1. As depicted, the PC 200 comprises a plurality of individual processing entities 202a . . . 202n (referred to collectively as processing entities 202). The individual processing 202 entities may comprise substantially the same structure and functionality as other processing entities. In addition to the processing entities 202 that process the data, the PC 200 also includes an external processing entity 204 which is responsible for communicating outside the PC. Both outbound 206 and inbound 208 packets are processed by the external processing entity 204.

The processing entities 202 may communicate data with other processing entities. It is noted that not all of the possible communication paths between processing entities are depicted in FIG. 2. Each of the processing entities 202 can also communicate with the external processing entity, as well as receiving data from external processing entity. When one of the processing entities 202 has a data packet to transfer outside of the PC 200, it sends the data packet to the external processing entity 204 which controls transmitting the data packet to the destination, or destinations. Similarly, when data is destined for one or more of the processing entities 202 in the PC 200, the data is received at the external processing entity and delivered to the processing entities.

The external processing entity may be added to a PC to handle external packet communication. When the external processing entity is included, the processing entities send packets that have to be transferred outside the PC to the external processing entity first to handle outbound packets. The external processing entity may select one of the packets received from the processing entities in the cluster to the destination that needs the packet. The destination may be for example one or more processing clusters in the architecture. Similarly, the external processing entity is the entity that receives inbound packets and broadcasts data to other internal PEs through internal data channels.

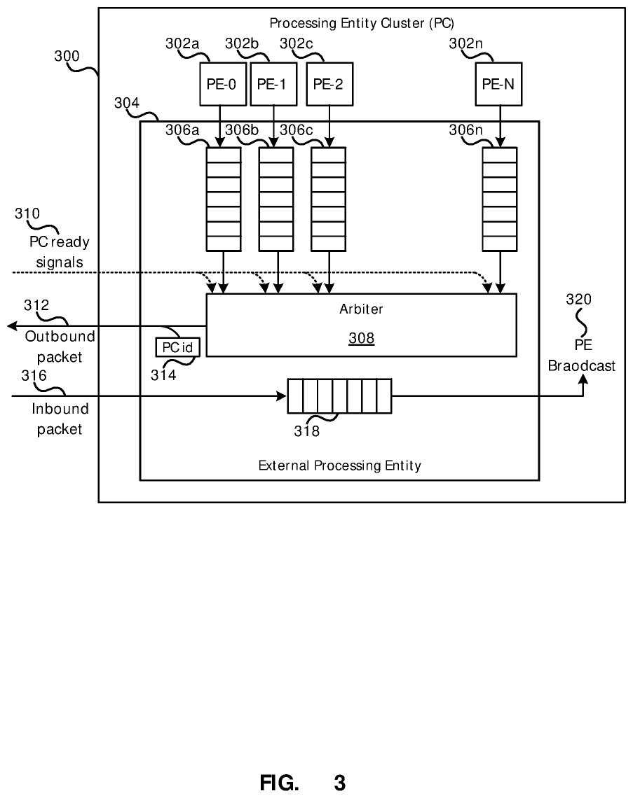

FIG. 3 depicts details of an external processing entity. The processing entity cluster (PC) 300 may be one of the PCs 102 depicted above in FIG. 1. The PC 300 comprises a plurality of processing entities 302a . . . 302n (referred to collectively as processing entities 302). Each of the processing entities 302 are in communication with an external processing entity 304 that handles inbound and outbound packets to and from the PC 300. The external processing entity 304 comprises a plurality of FIFO buffers 306a . . . 306n (referred to collectively as FIFO buffers 306) that are each associated with a respective one of the processing entities 302. The FIFO buffers receive data packets from the processing entities 302 that are destined for other PCs (not shown).

The external processing entity 304 comprises an arbiter 308 that selects a data packet from the FIFO buffers 306 for forwarding to the appropriate destination(s). In selecting the data packet, the arbiter 308 may receive ready signals from 310 from the other PCs. The arbiter 308 may select the data packet in one of the buffers 306 for forwarding once all of the destination PCs for the data packet are ready to receive. The selected packet may be forwarded to all of the destination PCs at the same time. The arbiter transmits the outbound packet 312, which may include an identifier 314 of the PC 300 indicating which PC sent the data packet. When a data packet from the other PCs is destined for the PC 300, the inbound packet 316 is received and stored in a FIFO buffer 318 before broadcasting to all of the processing entities 320.

As depicted in FIG. 3 the components that handle outgoing packets are similar to the switch in the PC interconnect, and include the PE buffers 306, PC id 314 and the arbiter 308. The arbiter is responsible for forwarding a packet in the FIFOs to all of the packet's destination PCs when the destination PCs all are ready to receive a packet. When the packet is sent, the PC ID is added as a payload, so that the processing entities of the processing clusters can recognize the source address. A FIFO buffer is used to handle incoming packets. The incoming packets are then broadcast to all of the internal processing entities. The internal processing entities are assumed to have knowledge of the data they need to perform computation based on its programming information.

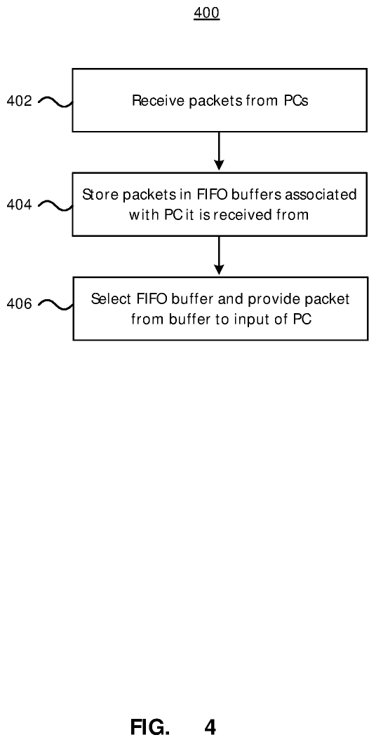

FIG. 4 depicts a method of communicating between processing clusters. The method 400 may be performed by a dynamic dataflow architecture such as that depicted above. The method receives packets from processing clusters (402). The packets received from a processing cluster may be received at switches, each associated with a respective PC. The received packets may be destined for one or more PCs and are transmitted to the switches associated with the destination PCs. The received packet may then be stored in each of the switches it was received at in a FIFO buffer that is associated with the processing cluster that transmitted the packet (404). A FIFO buffer, and so packet stored in the FIFO buffer, is selected and the packet provided to the processing cluster associated with the switch of the FIFO buffer (406). Each of the switches may select a packet from among the FIFO buffers of that switch to send to the associated PC.

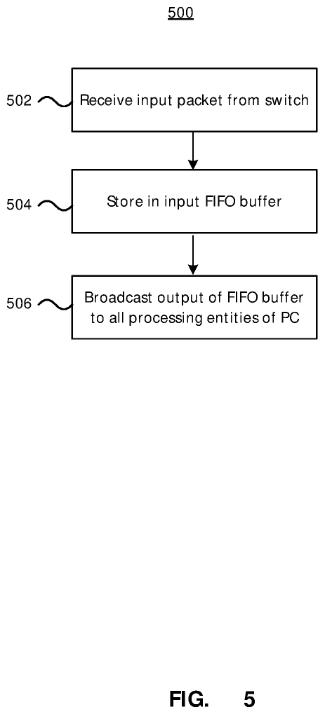

FIG. 5 depicts a method of providing external inputs to a processing cluster. The method 500 may be performed by an external processing entity such as that described above. The method 500 receives an input packet from a switch (502) of the interconnect network such as that described above. The received packet is stored in an input FIFO buffer (504). The packets are output from the input FIFO buffer and broadcast to all of the processing entities of the PC (506).

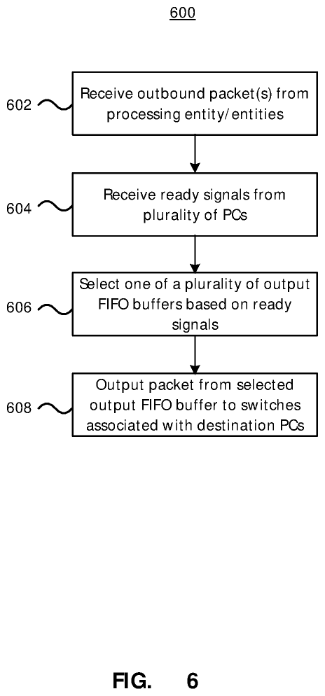

FIG. 6 depicts a method of providing output from a processing cluster to other processing clusters. The method 600 may be performed by an external processing entity such as that described above. The method 600 receives output packets from processing entities (602) which may be stored in FIFO buffers associated with respective processing entities. The outbound packets may specify, or be associated with, one or more destination PCs. Ready signals are received from a plurality of PCs (604). The ready signal indicates that the PC is ready to receive data. A packet from among the FIFO buffers is selected based on the ready signals (606). If all of the destination PCs of a packet are ready, as indicated by the ready signal, the packet may be selected. The selected packet is output to switches associated with the destination PCs (608).

The hierarchical dataflow architecture described above provides for communication between clusters of processing entities. When there are multiple packets heading to the same destination, the design is able to store packets as well as select and forward one of the packets when the target receivers can receive based on the ready signals from the receivers. In this way, the design works in a dynamic fashion without timing information from the compiler. This increases throughput, which is the number of packets processed per unit time. If a packet is destined to multiple destinations, the packet is multicast to all of the switches associated with the destination PCs at the same time. By doing this, the packet delivery time can be saved compared to mesh networks which can cause increased latency when multi-hop data transfers happen. Due to the single-cycle multicasting feature, the packets are guaranteed to be delivered in the same order that they are sent, which may be beneficial to avoid potential errors and simplifies design complexity and compilation process that can occur due to mixed packet arrival order.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A processing device comprising:
a plurality of processing entity clusters (PCs); and
a plurality of switches, each of the switches associated with a respective PC and comprising:
a plurality of FIFO (First Input First Output) packet buffers each associated with a respective PC of the plurality of PCs; and
an arbiter to select a packet from the plurality of FIFO packet buffers and provide it as input to the PC associated with the respective switch.

2. The processing device of claim 1, wherein the PCs each comprise:
a plurality of processing entities; and
an external processing entity for controlling inbound and outbound packets to and from the PC.

3. The processing device of claim 2, wherein the external processing entity comprises an arbiter that selects packets received from the plurality of processing entities to provide as output from the PC, the selection based on ready signals from other PCs.

4. The processing device of claim 3, wherein the external processing entity comprises a plurality of FIFO buffers each associated with respective processing entities of the PC, the received packets stored in the FIFO buffers and retrieved by the arbiter.

5. The processing device of claim 4, wherein the arbiter of the external processing entity outputs an identifier of the PC with the output from the PC.

6. A method of providing an interconnection between a plurality of processing clusters comprising:
receiving packets from the plurality of processing clusters at a plurality of switches, each of the switches associated with a respective processing cluster;
at each of the plurality of switches, storing the received packets in a first-in-first-out buffer of a plurality of FIFO buffers associated with the processing cluster the packets were received from; and
at each of the switches, selecting a packet from one of the FIFO buffers of the respective switch and providing as input the packet to the processing cluster associated with the respective switch.

7. The method of claim 6, further comprising:
receiving the input packet at a respective processing cluster and storing in an input FIFO buffer and broadcasting a packet output from the FIFO buffer to all processing entities of the processing cluster.

8. The method of claim 7, further comprising:
receiving at an arbiter of a respective processing cluster ready signals from a plurality of processing clusters and selecting a packet from plurality of FIFO output buffers, each associated with a respective processing entity of the processing cluster;
selecting one of the plurality of FIFO output buffers; and
outputting the packet from the selected FIFO output buffer to the plurality of FIFO buffers of the switches.
